(19) United States
(12) Patent Application Publication
(10) Pub. No.: US 2011/0093369 A1
(43) Pub. Date: Apr. 21, 2011

(54) Telephone minutes kiosk system

(76) Inventor: Luther Dewayne Gary, Detroit, MI (US)

(21) Appl. No.: 12/924,706

(22) Filed: Sep. 30, 2010

Related U.S. Application Data
(63) Continuation of application No. 11/604,080, filed on Nov. 24, 2006, now abandoned.
(60) Provisional application No. 60/739,461, filed on Nov. 25, 2005.

(51) Int. Cl. G06Q 30/00; G06Q 10/00

(52) U.S. Cl. 705/30

(57) ABSTRACT

A method of conducting business with a telephone subscriber, the method including the steps of forming a subscriber account containing value corresponding to telephone minutes. Value is added to the subscriber account by the presentation of funds in the form of currency value; acceptance of the presented funds; conversion of the currency value of the presented funds to corresponding value in telephone minutes; and depositing the corresponding value in telephone minutes into the telephone subscriber account. Services are provided to the subscriber, and telephone minutes are correspondingly debited from the subscriber account in response to the furnishing of services or products to the subscriber. Air time minutes are added (or credited) to the mobile telephone account of a mobile telephone subscriber with a predetermined telecommunicates carrier, which could be the administrator of a kiosk.

### RELATIONSHIP TO OTHER APPLICATION(S)

This application is a continuation of U.S. Ser. No. 11/604,080 filed on Nov. 24, 2006, which claims the benefit of U.S. Provisional Patent Application Ser. No. 60/739,461 Filed Nov. 25, 2005, the disclosure of which are incorporated herein by reference.

### BACKGROUND OF THE INVENTION

1. Field of the Invention

This invention relates generally to systems for conducting electronic business, and more particularly, to a system that provides, in exchange for telephone minutes, a plurality of services and products in a kiosk environment.

2. Description of the Related Art

Numerous types of kiosks are found in commercial buildings and malls for a variety of purposes, including office building and shopping mall directories, automatic teller machines (“ATMs”). airline check-in systems, and the like. However, there is no known kiosk arrangement that provides services to customer based on mobile telephone minutes in an accessible account.

Mobile telephone users generally do not have available a network of stations that enable convenient purchase of additional minutes that can be used on any of plural telecommunications carriers, mobile telephone recharging, transmission of telecopier documents and messages, access to the internet, or obtain cash-out, all related to consumption of telephone minutes credits.

It is, therefore, an object of this invention to provide an electronic value transaction system based on telephone minutes credits.

It is another object of this invention to provide a kiosk arrangement that includes an electronic value transaction system based on telephone minutes credits.

It is also an object of this invention to provide a kiosk arrangement that permits mobile telephone subscribers to purchase air time minutes.

It is a further object of this invention to provide an electronic value transaction system that provides telecommunications services charged against telephone minutes credits.

It is additionally an object of this invention to provide an electronic value transaction system that provides cash-out services charged against telephone minutes credits.

It is yet a further object of this invention to provide a system of transacting telephone minutes across a telecommunications network.

It is also another object of this invention to provide a system of transacting telephone minutes across an internet network.

### SUMMARY OF THE INVENTION

The foregoing and other objects are achieved by this invention which provides a method of conducting business with a mobile telephone subscriber, the method including the steps of:

forming a mobile telephone subscriber account containing value corresponding to telephone minutes;

adding value to the mobile telephone subscriber account by:
presenting funds in the form of currency value;
accepting the presented funds;
converting the currency value of the presented fund to corresponding value in telephone minutes; and
depositing the corresponding value in telephone minutes into the mobile telephone subscriber account;

providing services to the mobile telephone subscriber; and

debiting telephone minutes from the mobile telephone subscriber account in response to the step of providing services to the mobile telephone subscriber.

Telephone usage minutes are added (or credited) to the mobile telephone account of the mobile telephone subscriber with a predetermined telecommunicates carrier.

In one embodiment of the invention, the step of forming a mobile telephone subscriber account is performed at a kiosk. Also, the step of providing services to the mobile telephone subscriber is performed at a kiosk.

Further services that are made available to the mobile telephone subscriber are:

the charging of the battery of the mobile telephone;

the providing of internet access;

the providing of telephone access, which may be in the form of voice over internet protocol (“VoIP”) telephone services;

the providing of a telecopier facility;

the providing of a facility for withdrawal of equivalent cash value from the mobile telephone subscriber account; and

account access via a remote computer over an internet protocol (“IP”) network.

In accordance with a further method aspect of the invention, there is provided a method of conducting business with a mobile telephone subscriber, the method including the steps of:

forming a mobile telephone subscriber account at a remote server, the mobile telephone subscriber account containing value corresponding to telephone minutes;

adding value to the mobile telephone subscriber account by:
presenting funds in the form of currency value at a local terminal;
accepting the presented funds in response to data contained in the remote server;
converting the currency value of the presented fund to corresponding value in telephone minutes; and
depositing the corresponding value in telephone minutes into the mobile telephone subscriber account at the remote server;

providing services at a local terminal to the mobile telephone subscriber; and

debiting telephone minutes from the mobile telephone subscriber account at the remote server in response to the step of providing services to the mobile telephone subscriber.

In one embodiment of this further method aspect of the invention, the step of forming a mobile telephone subscriber account at a remote server includes the further step of forming a data connection between the local terminal and the remote server. The internet is used in some embodiments to form the data connection between the local terminal and the remote server. In other embodiments, however, the data connection between the local terminal and the remote server is performed telephonically, using POTS, T1 connection, or other known telephone transmission system.

In accordance with an apparatus aspect of the invention, there is provided a multi-user commercial transaction station that is provided with a central processing system. A user terminal is coupled to the processing system, the terminal having a user interface arrangement for entering user data, such as a keyboard, and a monitor for viewing responsive data from the central processing system. A memory stores account information for each user, the account information including a quantum of telephone minutes owned by each such user. A plurality of user service modules for use by the user are additionally provided, the use of any such service module being responsive to a debit from the stored account information of the user. The debit corresponds, in some embodiments, to predeterminable numbers of telephone minutes.

In addition to the foregoing, the memory stores data that is received from a remote server. Such data includes in some embodiments of the invention conversion factors between the usage minutes of the administrator and those of other telecommunications carriers.

In one embodiment of this apparatus aspect of the invention, there is provided a telecommunications port for facilitating communication between the central processing system and a remote server. The telecommunications port may be a telephone port, or a data port configured for the transmission of data over the internet.

In a still further embodiment, there is provided a printing arrangement for issuing to the user printed account information responsive to a remaining quantum of telephone minutes owned by the user. Also, there is further provided a facility for receiving value corresponding to currency, the received value being converted to corresponding value in telephone minutes owned by the user.

### BRIEF DESCRIPTION OF THE DRAWING

Comprehension of the invention is facilitated by reading the following detailed description, in conjunction with the annexed drawing, in which:

FIG. 1 is a function block representation of a simplified methodology conducted in accordance with the principles of the invention;

FIG. 2 is a continuation of the function block representation of FIG. 1;

FIG. 3 is a schematic representation of a specific illustrative embodiment of the invention that enables interconnection between various kiosks and remote servers via the internet and telephonically;

FIG. 4 is a simplified schematic representation of a kiosk station structured in accordance with the principles of the invention;

FIGS. 5(a), 5(b), and 5(c) simplified plan representations of respective function modules useful in the practice of a specific illustrative embodiment of the invention; and

FIG. 6 is a top plan representation of a kiosk arrangement that employs the function modules of FIGS. 5(a), 5(b), and 5(c) in an annular distribution about a central structure.

### DETAILED DESCRIPTION

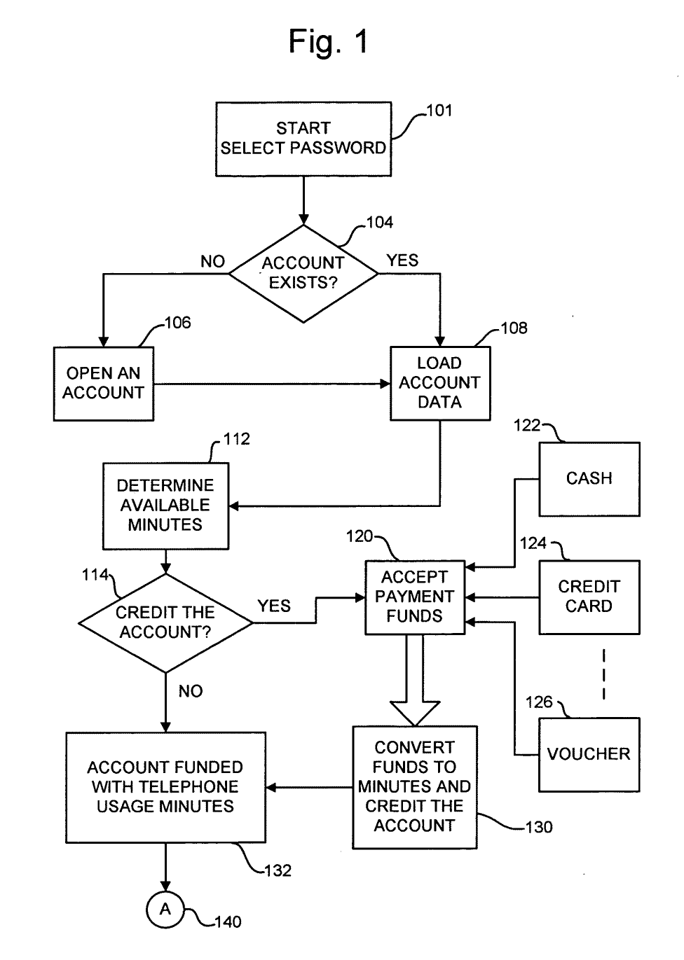

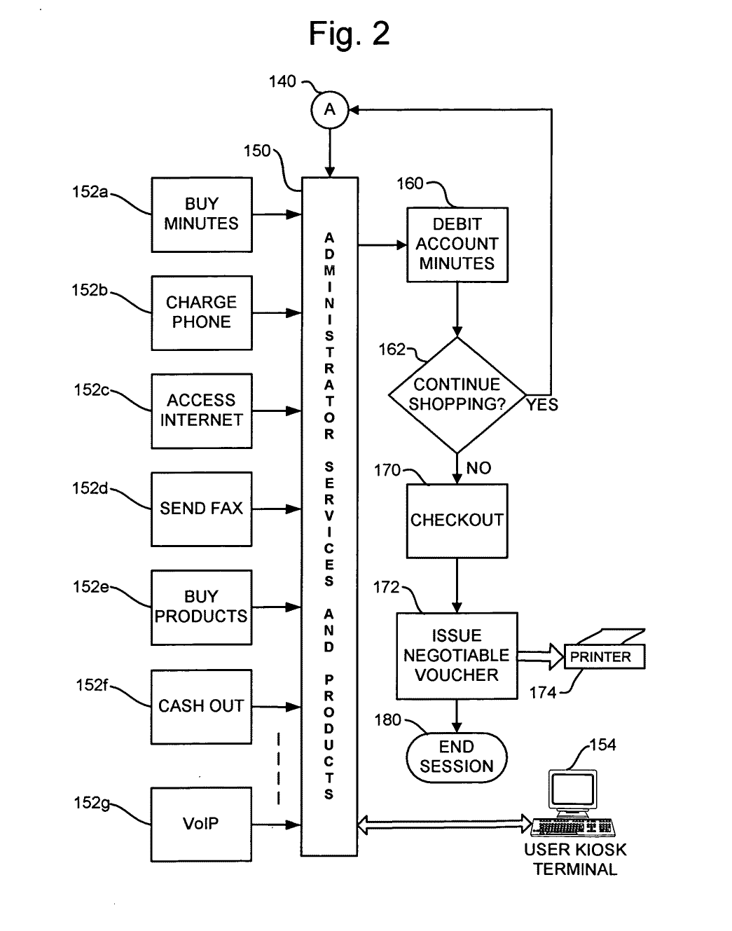

FIG. 1 is a function block representation of a simplified methodology conducted in accordance with the principles of the invention. As shown in this figure, a user (not shown) starts the process at function block 101 by selecting a password. A determination is then made at function block 104 as to whether the user has an account in the system. If the user does not have an account, an account is opened at function block 106 and the account data is loaded into the system at function block 108. Of course, if the user has an existing account, the account data is loaded without the need of opening another account. Once the account data is loaded, a determination of available minutes in the user's account is made at function block 112. The user then determines at function block 114 whether he or she desires to add credit to the account. If so, payment funds are accepted at function block 120. The payment funds may be derived from a cash deposit at function block 122, a credit card debit at function block 124, the presentation of a negotiable voucher at function block 126, or any other acceptable form of payment. The paid funds are converted to telephone minutes at function block 130 and the user's account is correspondingly credited. Function block 132 represents the account funded with minutes. Of course, if the user desires not to add additional credit to the account, the process continues directly from decision function block 114 directly to function block 132, as shown in the figure. The process then continues onto FIG. 2 at node A, designated in FIG. 1 with designation 140.

FIG. 2 is a continuation of the function block representation of FIG. 1. As shown in this figure, node A, which is designated herein as 140, corresponds to node A in FIG. 1. In FIG. 2, the process continues to function block 150 which is denominated as “administrator services and products.” On the left-hand side of function block 150 is a plurality of function blocks that represent services and/or products that can be purchased by the user. These include the purchase of minutes at function block 152a, the charging of the battery of the mobile phone (not shown) at function block 152b, the providing of access to the internet at function block 152c, telecopier services at function block 152d, the purchase of products at function block 152e, cash withdrawal at function block 152f, and telephone service, such as VoIP service at function block 152g.

The processes of function block 150 are controlled in response to user information that is entered at a user kiosk terminal 154. The user kiosk terminal is provided with a conventional keyboard (not specifically designated) for entering data, and a data monitor for viewing responses from the administrator system in function block 150.

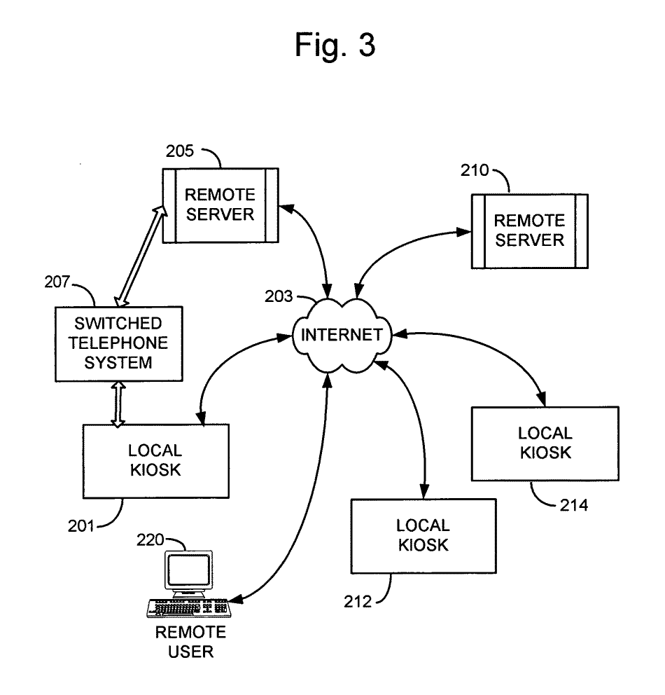

FIG. 3 is a schematic representation of a specific illustrative embodiment of the invention that enables interconnection between various kiosks and remote servers via the internet and telephonically via the public switched telephone system. As shown in this figure, a local kiosk 201 is coupled to the internet, which is generally designated as 203. Local kiosk 201 communicates with a remote server 205 via internet 203. However, in this specific illustrative embodiment of the invention, local kiosk 201 also communicates with remote server 205 via the switched telephone system designated generally as 207. In a network embodiment of the invention, a plurality of local kiosks, such as local kiosk 212 and local kiosk 214, also communicate with remote server 205 via internet 203, and with remote server 210, also via the internet.

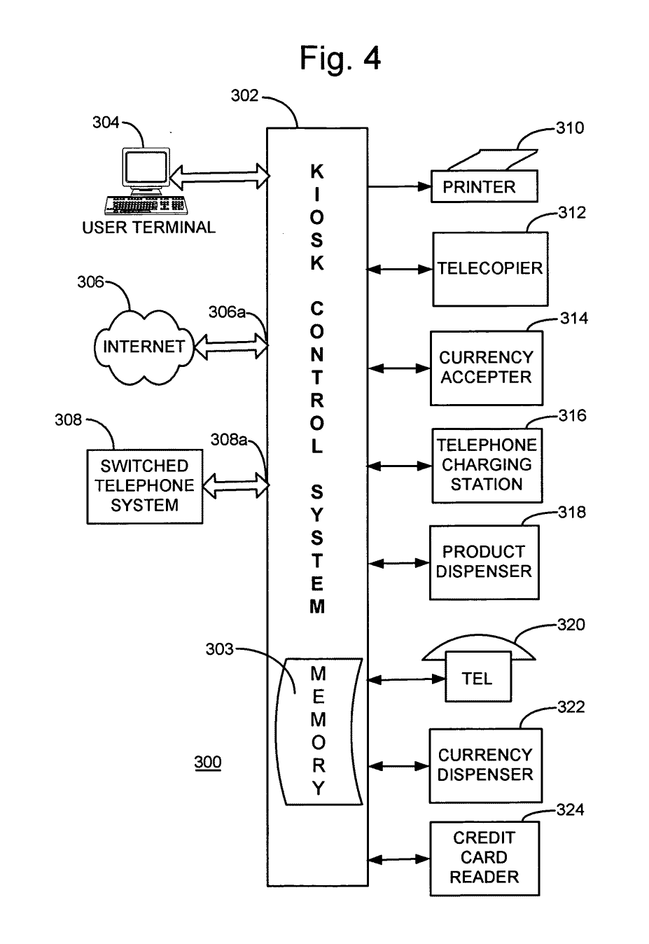

FIG. 4 is a simplified schematic representation of a kiosk station 300 structured in accordance with the principles of the invention. The kiosk station has a kiosk control system 302 in which is contained a memory 303. Communication between the kiosk control system and a user (not shown) is effected via a terminal 304, which as previously discussed, is provided with a keyboard for entering data and a monitor.

In this embodiment, kiosk control system 302 communicates with internet 306 at a telecommunications port 306a which is configured to transmit and receive data in internet protocol format. In addition, the kiosk control system communicates with the public switched telephone system 308 at a telephone port 308a. In some embodiments, telephone port 308a is not limited to plain old telephone service (“POTS”), but may include within the scope of the invention, any known telephonic interconnection arrangement, such as a T1 connection.

Data that is received via the internet or the telephone system is stored in the memory. Such data includes, for example, an operating system, information relating to the account of the user, and conversion factors that are useful to determine equivalence between the respective values of the telephone minutes of various carriers.

The right hand side of kiosk control system 302 shows a plurality of function blocks corresponding to elements of structure that enable respective features and functionalities of the kiosk station. A printer 310 is provided in this embodiment to enable the user to print a receipt of the transaction, or to receive telecopier messages. In addition, printer 310 can be employed to print a negotiable voucher (not specifically designated) representing value in the user's account or currency that can be negotiated for other products or services. For example, in an embodiment of the invention where the kiosk control system is installed within a shopping mall (not shown), the negotiable voucher can be used at one or more vendors in the shopping mall as equivalent currency value.

In this embodiment, kiosk station 300 is provided with a telecopier arrangement 312 that permits documents to be scanned for the purpose of transmitting same as faxes via the internet and/or the public switched telephone system.

A currency acceptor 314 enables the user's account to be credited by a cash payment. In some embodiments of the invention, credit can be added to an account by a credit card transaction using a credit card reader 324 that communicates with a remote verification system in a conventional manner via the internet or the telephone system. As discussed herein, currency value is converted to corresponding telephone minutes value in the practice of the invention.

One of the peripheral services that can be provided in certain embodiments of the invention is effected via a telephone charging station 316. Thus, a user who has exhausted the battery in his or her mobile phone can recharge the battery at this charging station. Small items, such as telephone accessories, can be dispensed at a product dispenser 316. One such product is, for example, an adapter that permits the particular model of user mobile telephone to be connected to telephone charging station 316.

Kiosk station 300 provides telephone service via a telephone handset arrangement 320. Conventional telephone service can be provided via the public switched telephone system or via the internet as VoIP.

In some embodiments, users can cash out a portion of the telephone minutes value in their accounts via a currency dispenser 322. The specifics of the transaction are viewed at terminal 304, and a receipt is printed at printer 310. As previously noted, the cash-out process can yield a negotiable voucher (not shown) from printer 310.

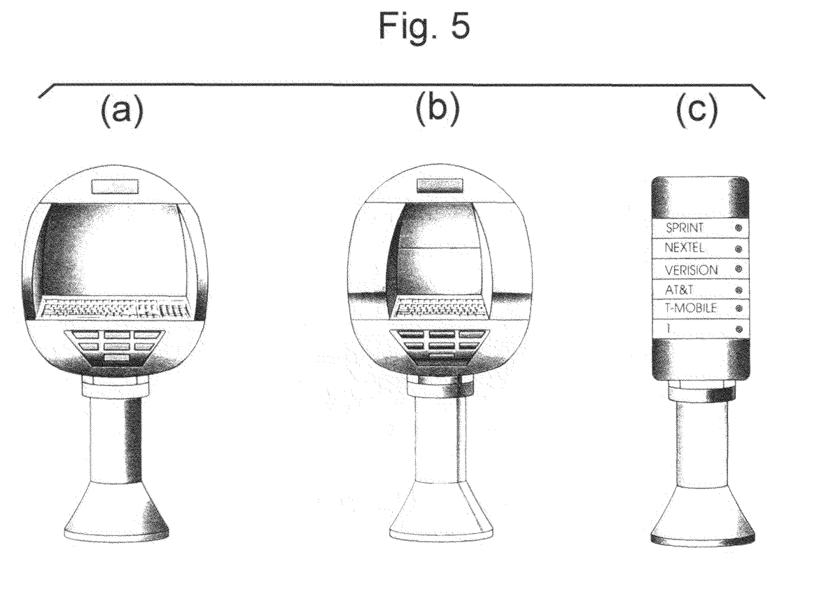

FIGS. 5(a), 5(b), and 5(c) are simplified plan representations of respective function modules useful in the practice of a specific illustrative embodiment of the invention. The embodiments of FIG. 5 are function-specific. Thus, for example, the module represented in FIG. 5(a) is configured for receipt and transmission of e-mail messages. The function module represented in FIG. 5(b) is configured to create messages that are transmitted by facsimile. The module represented in FIG. 5(c) is configured to facilitate the selection of mobile telephone service carriers by the user. By way of example, a user desiring to apply this or her telephone minutes to a selected carrier will do so at this module. Mobile telephone subscribers who have an existing account with a carrier would find the system of the present invention useful, particularly in situations where they have a need for additional minutes but do not wish to pay the high per-minute rates that are charged by many carriers once the number of minutes in the respective contract plan is exceeded.

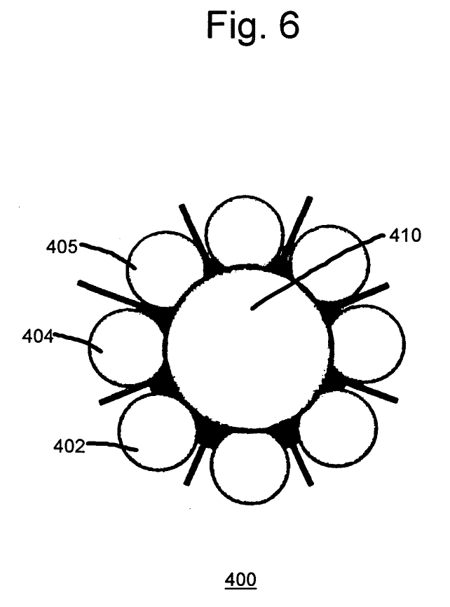

FIG. 6 is a top plan representation of a kiosk arrangement that employs the function modules of FIGS. 5(a), 5(b), and 5(c). As shown in this figure, various modules are organized around a central structure 410. In this embodiment, module 402, which may correspond to the e-mail module of FIG. 5(a), is disposed in determined relation to module 404, which may be the telecopier module of FIG. 5(b), and module 405 may correspond to the module represented in FIG. 5(c). Of course, in some embodiments of the invention, all of the functionalities of the kiosk arrangement can be incorporated into a single module. Additionally, several other types of modules can be incorporated in the practice of the invention, such as a telephone module for telephone 320 in FIG. 4, or a telephone battery charging station 316, also as shown in FIG. 4.

Although the invention has been described in terms of specific embodiments and applications, persons skilled in the art can, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

What is claimed is:

1. A system for conducting business with a mobile telephone subscriber, the system comprising:
a stand-alone kiosk having a housing;
a data input arrangement, coupled to said kiosk;
a monitor arrangement, coupled to said kiosk;
a kiosk control system, contained within the housing of said kiosk;
a memory system, coupled to said kiosk control system and contained within the housing of said kiosk;
a mobile telephone subscriber account memory section contained within said memory system for storing subscriber account data corresponding to telephone minutes available to the mobile telephone subscriber;
a value receiving peripheral subsystem coupled to said kiosk for incrementing the mobile telephone subscriber account data in response to the value received at said value receiving peripheral subsystem;
a currency conversion data section in the memory system for converting the value received at said value receiving peripheral subsystem into corresponding telephone minutes; to the mobile telephone subscriber; and
a peripheral product subsystem coupled to said stand-alone kiosk for providing a product to the mobile telephone subscriber.

2. The system of claim 1, wherein said mobile telephone subscriber account memory section contained within said memory system contains account data entered at said data input arrangement coupled to said kiosk.

4. The system of claim 1, wherein the telephone minutes correspond to a predetermined telecommunications carrier.

5. The system of claim 1, wherein said peripheral service subsystem is a charger peripheral subsystem for charging a battery of a mobile telephone of the mobile telephone subscriber.

6. The system of claim 1, wherein said peripheral service subsystem provides internet access to the mobile telephone subscriber.

7. The system of claim 3, wherein said peripheral service subsystem provides telephone access to the mobile telephone subscriber.

8. The system of claim 7, wherein the telephone access is voice over internet protocol (“VoIP”) telephone services.

9. The system of claim 3, wherein said peripheral product subsystem provides a currency value.

10. The system of claim 1, wherein there is further provided a remote server that communicates with the memory system over an internet protocol (“IP”) network.

11. A multi-user commercial transaction kiosk comprising:
a central processing system contained within the kiosk;
a terminal coupled to said processing system, said terminal having a user interface arrangement for entering user data and viewing responsive data from said central processing system;
a memory contained within the kiosk for storing account information for each user, the account information including a quantum of telephone minutes available to each user;
a plurality of user service modules for use by the user, the use of any such service module being responsive to a debit from the account information of the user contained in the memory, the debit corresponding to predeterminable numbers of telephone minutes.

12. The multi-user commercial transaction station of claim 11, wherein there is further provided a telecommunications port for facilitating communication between said central processing system and a remote server.

13. The multi-user commercial transaction station of claim 11, wherein there is further provided a printing arrangement for issuing to the user printed account information responsive to a remaining quantum of telephone minutes that are available to the respective user.

14. The multi-user commercial transaction station of claim 11, wherein there is further provided a facility for receiving value corresponding to currency, the received value being converted to data stored in the memory corresponding to telephone minutes that are available to a corresponding user.
